(19) United States
(12) Patent Application Publication
(10) Pub. No.: US 2018/0254452 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventors: Kosuke KURAKANE, Osaka (JP); Chikara MURAKAMI, Osaka (JP)

(21) Appl. No.: 15/910,113

(22) Filed: Mar. 2, 2018

(30) Foreign Application Priority Data
Mar. 3, 2017 (JP) 2017-041083

(51) Int. Cl. H01M 2/16; H01M 2/14

(52) U.S. Cl. CPC H01M 2/1653; H01M 10/0525; H01M 2/1686; H01M 2/145

(57) ABSTRACT

To provide a nonaqueous electrolyte secondary battery separator that allows a nonaqueous electrolyte secondary battery including the nonaqueous electrolyte secondary battery separator to have an excellent cycle characteristic, a nonaqueous electrolyte secondary battery separator has, over a 10 μm×10 μm region of a polyolefin porous film included therein, an average outermost surface area within a range of not less than 105.5 μm² and not more than 115.5 μm² as measured with use of a scanning probe microscope.

This Nonprovisional application claims priority under 35 U.S.C. § 119 on Patent Application No. 2017-041083 filed in Japan on Mar. 3, 2017, the entire contents of which are hereby incorporated by reference.

### TECHNICAL FIELD

The present invention relates to (i) a separator for a nonaqueous electrolyte secondary battery (hereinafter referred to as a “nonaqueous electrolyte secondary battery separator”), (ii) a laminated separator for a nonaqueous electrolyte secondary battery (hereinafter referred to as a “nonaqueous electrolyte secondary battery laminated separator”), (iii) a member for a nonaqueous electrolyte secondary battery (hereinafter referred to as a “nonaqueous electrolyte secondary battery member”), and (iv) a nonaqueous electrolyte secondary battery.

### BACKGROUND ART

Nonaqueous electrolyte secondary batteries such as a lithium secondary battery are currently in wide use as (1) batteries for devices such as a personal computer, a mobile telephone, and a portable information terminal or on-vehicle batteries.

A known example of a separator for use in such a nonaqueous electrolyte secondary battery is a porous film containing a polyolefin as a main component as disclosed in Patent Literature 1.

### CITATION LIST

[Patent Literature 1]

Japanese Patent Application Publication, Tokukaihei, No. 11-130900 (Publication Date: May 18, 1999)

### SUMMARY OF INVENTION

### Technical Problem

Conventional art such as the above may let a nonaqueous electrolyte secondary battery fail to maintain its initial discharge capacity after repeated charge and discharge cycles. Conventional art such as the above, in other words, fails to provide a sufficient cycle characteristic and leaves room for improvement.

An aspect of the present invention has been attained in view of the above issue. It is an object of an aspect of the present invention to provide a nonaqueous electrolyte secondary battery separator that allows a nonaqueous electrolyte secondary battery including the nonaqueous electrolyte secondary battery separator to have an excellent cycle characteristic.

### Solution to Problem

The inventors of the present invention have uniquely discovered that having the outermost surface area of a porous film within a particular range makes it possible to achieve an improved cycle characteristic, and have thereby completed the present invention.

A nonaqueous electrolyte secondary battery separator in accordance with an aspect of the present invention is a nonaqueous electrolyte secondary battery separator, including: a polyolefin porous film, the polyolefin porous film having, over a 10 μm×10 μm region thereof, an average outermost surface area within a range of not less than 105.5 μm² and not more than 115.5 μm² which average outermost surface area has been measured under a scanning probe microscope.

A nonaqueous electrolyte secondary battery laminated separator in accordance with an aspect of the present invention includes: a nonaqueous electrolyte secondary battery separator in accordance with an aspect of the present invention; and an insulating porous layer.

A nonaqueous electrolyte secondary battery member in accordance with an aspect of the present invention includes: a positive electrode; a nonaqueous electrolyte secondary battery separator in accordance with an aspect of the present invention or a nonaqueous electrolyte secondary battery laminated separator in accordance with an aspect of the present invention; and a negative electrode, the positive electrode, the nonaqueous electrolyte secondary battery separator or the nonaqueous electrolyte secondary battery laminated separator, and the negative electrode being arranged in this order.

A nonaqueous electrolyte secondary battery in accordance with an aspect of the present invention includes: a nonaqueous electrolyte secondary battery separator in accordance with an aspect of the present invention or a nonaqueous electrolyte secondary battery laminated separator in accordance with an aspect of the present invention.

### Advantageous Effects of Invention

An aspect of the present invention advantageously makes it possible to provide a nonaqueous electrolyte secondary battery separator that allows a nonaqueous electrolyte secondary battery including the nonaqueous electrolyte secondary battery separator to have an excellent cycle characteristic.

### DESCRIPTION OF EMBODIMENTS

The following description will discuss an embodiment of the present invention. The present invention is, however, not limited to the embodiment below. The present invention is not limited to the arrangements described below, but may be altered in various ways by a skilled person within the scope of the claims. The present invention also encompasses in its technical scope any embodiment based on an appropriate combination of technical means disclosed in different embodiments. Note that numerical expressions in the form of “A to B” herein mean “not less than A and not more than B” unless otherwise stated.

[1. Nonaqueous Electrolyte Secondary Battery Separator]

A nonaqueous electrolyte secondary battery separator in accordance with an embodiment of the present invention is a nonaqueous electrolyte secondary battery separator, including: a polyolefin porous film, the polyolefin porous film having, over a 10 μm×10 μm region thereof, an average outermost surface area within a range of not less than 105.5 μm² and not more than 115.5 μm² which average outermost surface area has been measured under a scanning probe microscope.

The present specification may use the simple term “porous film” to refer to a polyolefin porous film. Further, the present specification uses (i) the term “machine direction (MD)” about a porous film to refer to a direction in which the porous film is conveyed during the production and (ii) the term “transverse direction (TD)” about a porous film to refer to a direction perpendicular to the MD of the porous film.

<Polyolefin Porous Film>

A nonaqueous electrolyte secondary battery separator in accordance with an embodiment of the present invention includes a polyolefin porous film, and is preferably constituted by a polyolefin porous film. A porous film has therein many pores, connected to one another, so that a gas and a liquid can pass through the porous film from one side to the other side. The porous film can he a nonaqueous electrolyte secondary battery separator or a base material of a later-described nonaqueous electrolyte secondary battery laminated separator. In a case where a battery including a nonaqueous electrolyte secondary battery separator including a porous film generates heat, the porous film melts so as to make the nonaqueous electrolyte secondary battery separator non-porous. Thus, the porous film can impart a shutdown function to the nonaqueous electrolyte secondary battery separator.

The term “polyolefin porous film” refers to a porous film containing a polyolefin-based resin as a main component The phrase “containing a polyolefin-based resin as a main component” means that the porous film contains a polyolefin-based resin at a proportion of not less than 50% by volume, preferably not less than 90% by volume, more preferably not less than 95% by volume, relative to all the materials of the porous film.

Examples of the polyolefin-based resin that the porous film contains as a main component include, but are not particularly limited to, homopolymers and copolymers both of which are thermoplastic resins and are each produced through polymerization of a monomer(s) such as ethylene, propylene, 1-butene, 4-methyl-1-pentene, and/or 1-hexene. Specifically, examples of such homopolymers include polyethylene, polypropylene, and polybutene, and examples of such copolymers include an ethylene-propylene copolymer. The porous film can include a layer containing only one of these polyolefin-based resins and/or a layer containing two or more of these polyolefin-based resins. Among these, polyethylene is preferable as it is capable of preventing (shutting down) a flow of an excessively large electric current at a lower temperature. A high molecular weight polyethylene containing ethylene as a main component is particularly preferable. Note that the porous film can contain a component(s) other than polyolefin as long as such a component does not impair the function of the layer.

Examples of the polyethylene encompass low-density polyethylene, high-density polyethylene, linear polyethylene (ethylene-a-olefin copolymer), and ultra-high molecular weight polyethylene. Among these polyethylenes, an ultra-high molecular weight polyethylene is more preferable, and an ultra-high molecular weight polyethylene containing a high molecular weight component having a weight-average molecular weight of 5×10⁵ to 15×10⁶ is even more preferable. In particular, the polyolefin-based resin more preferably contains a high molecular weight component having a weight-average molecular weight of not less than 1,000,000 because such a polyolefin-based resin allows a porous film and a nonaqueous electrolyte secondary battery laminated separator to have a higher strength.

The porous film has, over a 1.0 μm×10 μm region thereof, an average outermost surface area within a range of not less than 105.5 μm² and not more than 115.5 μm² as measured under a scanning probe microscope (SPM). The average outermost surface area is preferably not less than 106 μm², more preferably not less than 108 μm², and is preferably not more than 115 μm², more preferably not more than 113 μm².

The present specification uses the term “outermost surface area” to refer to a surface area of a porous film which surface area is measured by scanning the surface of the porous film with use of a probe of the scanning probe microscope. The outermost surface area is an area of a resin portion of the porous film which resin portion has a depth of approximately 0.4 μm from the outermost surface of the porous film. The outermost surface area can be measured by scanning a 10 μm×10 μm region of the surface of a porous film under a scanning probe microscope, in particular, under an atomic force microscope (AFM) in a contact mode. The present specification uses the term “average outermost surface area” to mean the average of four outermost surface areas measured at respective portions of a porous film.

In a case where a porous film has a flat surface, the outermost surface area of a 10 μm×10 μm region of the surface is simply 100 μm². A 10 μm×10 μm region having a outermost surface area of more than 100 μm² means the porous film having a surface with asperities. In this case, the outermost surface area is more than 100 μm² as those asperities are scanned with the probe. The outermost surface area is, as described below, presumed to influence the area of contact between an electrode composite layer and a nonaqueous electrolyte secondary battery separator. The inventors of the present invention thus studied not the mere height or depth of asperities but particularly the outermost surface area measured by scanning a surface with asperities to complete the present invention.

In a case where the average outermost surface area is not less than 105.5 μm², the area of contact between an electrode composite layer and a nonaqueous electrolyte secondary battery separator is large as compared to a porous film having a flat surface. This arrangement achieves good adhesiveness between the electrode composite layer and the nonaqueous electrolyte secondary battery separator. With the above arrangement, even if the electrode composite layer is expanded and shrunk repeatedly during charge and discharge cycles, displacement is less likely between the positive electrode and the negative electrode or between the electrode composite layer and the nonaqueous electrolyte secondary battery separator, thereby tending to achieve an excellent cycle characteristic. In a case where the average outermost surface area is not more than 115.5 μm², the area of contact between an electrode composite layer and a nonaqueous electrolyte secondary battery separator is not excessively large. This arrangement prevents oxidative degradation from occurring easily at that surface of resin included in the nonaqueous electrolyte secondary battery separator which is in contact with the electrode composite. Further, the above arrangement allows a sufficient amount of electrolyte to be supplied at the interface between the electrode composite layer and the nonaqueous electrolyte secondary battery separator, and thereby reduces deposition of lithium. The above arrangement can thus prevent the performance of a nonaqueous electrolyte secondary battery separator from decreasing and improve the cycle characteristic as a result.

The porous film has a thickness of preferably 4 μm to 40 μm, more preferably 5 μm to 20 μm. It is preferable that the porous film have a thickness of not less than 4 μm because it is possible to sufficiently prevent an internal short circuit of a battery. Meanwhile, it is preferable that the porous film have a thickness of not more than 40 μm because it is possible to prevent a nonaqueous electrolyte secondary battery from being large in size.

The porous film typically has a weight per unit area of preferably 4 g/m² to 20 g/m², more preferably 5 g/m² to 12 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. This allows a nonaqueous electrolyte secondary battery separator to have sufficient ion permeability.

The porous film has a porosity of preferably 20% by volume to 80% by volume, more preferably 30% by volume to 75% by volume. This makes it possible to (i) retain a larger amount of electrolyte and (ii) reliably prevent (shut down) a. flow of an excessively large electric current at a lower temperature.

The porous film has pores each having a pore size of preferably not more than 0.3 μm, more preferably not more than 0.11 μm. This allows the nonaqueous electrolyte secondary battery separator to achieve sufficient ion permeability and to prevent particles, constituting an electrode, from entering the nonaqueous electrolyte secondary battery separator.

<Method for Producing Porous Film>

The porous film may be produced by any method, and may be produced by, for example, a method including the steps of melt-kneading a polyolefin-based resin and an additive(s), extruding the resulting mixture to prepare a polyolefin resin composition, stretching the polyolefin resin composition, cleaning the polyolefin resin composition, and drying the polyolefin resin composition.

Specifically, the method can include the steps of;

(A) melt-kneading a polyolefin-based resin and an additive(s) in a kneader to obtain a polyolefin resin composition;

(B) extruding, through a T-die of an extruder, the melted polyolefin resin composition obtained in the step (A), and then shaping the polyolefin resin composition into a sheet while cooling the polyolefin resin composition to obtain a sheet-shaped polyolefin resin composition;

(C) stretching the sheet-shaped polyolefin resin composition obtained in the step (B);

(D) cleaning, with use of a cleaning liquid, the polyolefin resin composition stretched in the step (C); and

(E) drying and/or heat-fixing the polyolefin resin composition cleaned in the step (D) to obtain a polyolefin porous film.

In the step (A), the polyolefin-based resin is used in an amount within a range of preferably 6% by weight to 45% by weight, more preferably 9% by weight to 36% by weight, with respect to 100% by weight of the polyolefin resin composition to be obtained.

Examples of the additive in the step (A) include; phthalate esters such as dioctyl phthalate; un saturated higher alcohol such as oleyl alcohol; saturated higher alcohol such as stearyl alcohol; low molecular weight polyolefin-based resin such as paraffin wax; petroleum resin; and liquid paraffin. Examples of the petroleum resin include (i) an aliphatic hydrocarbon resin obtained through polymerization of a C5 petroleum fraction such as isoprene, pentene, and pentadiene as a main material, (ii) an aromatic hydrocarbon resin obtained through polymerization of a C9 petroleum fraction such as indene, vinyltoluene, and methyl styrene as a main material, a copolymer resin of the aliphatic hydrocarbon resin and the aromatic hydrocarbon resin, (iv) an alicyclic saturated hydrocarbon resin obtained through hydrogenation of any of the resins (i) to (iii), and (v) various mixtures of the resins (i) to (iv). The petroleum resin is preferably an alicyclic saturated hydrocarbon resin. The above additives may be used alone or may be used in combination.

In the step (A), it is preferable to use, as the additive, a combination of an additive) that is in a solid state at normal temperature (approximately 25° C.) and an additive (ii) that is in a liquid state at normal temperature.

The additive (1) is preferably a petroleum resin. Among petroleum resins, the additive (i) is preferably an aliphatic hydrocarbon resin having a softening point within a range of 90° C. to 125° C. or an alicyclic saturated hydrocarbon resin having a softening point within a range of 90° C. to 125° C., more preferably an alicyclic saturated hydrocarbon resin having a softening point within a range of 90° C. to 125° C. In the step (A), the additive (i) is used in an amount within a range of preferably 0.5% by weight to 40% by weight, more preferably 1% by weight to 30% by weight, with respect to 100% by weight of the polyolefin resin composition to be obtained. The additive (ii) is preferably liquid paraffin, which serves as a pore forming agent. In the step (A), liquid paraffin is used in an amount within a range of preferably 50% by weight to 90% by weight, more preferably 60% by weight to 85% by weight, with respect to 100% by weight of the polyolefin resin composition to be obtained.

In the step (A), the polyolefin-based resin and the additive are mixed for dispersion in a state where the polyolefin-based resin and the additive are compatible with each other. It is preferable to knead the additive (i) and the polyolefin-based resin, then add the additive (ii), and further knead the resulting mixture. When the additive (ii) is added, the kneader has an internal temperature of preferably not lower than 160° C. and not higher than 210° C., more preferably not lower than 183° C. and not higher than 195° C. If the kneader has a low internal temperature when the additive (ii) is added, the ingredients will not be dispersed uniformly, thereby tending to result in a separator having a small outermost surface area. If the kneader has a high internal temperature when the additive (ii) is added, the ingredients will be dispersed uniformly, thereby tending to result in a separator having a large outermost surface area.

In the step (A), the kneader applies, at the outlet, a resin pressure of preferably not less than 5.0 MPa and less than 8.5 MPa, more preferably not less than 6.0 MPa and less than 8.0 MPa. If the pressure is low, the polyolefin-based resin and the additive are not dispersed uniformly, thereby tending to result in a separator having a small outermost surface area. If the pressure is high, the polyolefin-based resin and the additive are dispersed uniformly, thereby tending to result in a separator having a large outermost surface area.

For cooling in the step (B), it is possible to use, for example, (i) a method in which the polyolefin resin composition is brought into contact with a cooling medium such as cool air, cooling water, or the like or (ii) a method in which the polyolefin resin composition is brought into contact with a cooling roller. The method in which the polyolefin resin composition is brought into contact with a cooling roller is preferable. The cooling operation causes the melted polyolefin resin composition to be microphase-separated, with the result of microphases being fixed. The microphase structure is influenced by the cooling temperature and cooling rate. Raising the cooling temperature or decreasing the cooling rate causes the microphase structure to be rough, thereby tending to result in a separator having a small outermost surface area. Lowering the cooling temperature or increasing the cooling rate causes the microphase structure to be tight, thereby tending to result in a separator having a large outermost surface area.

The cooling roller has a temperature of preferably not lower than 0° C. and lower than 60° C., more preferably not lower than 20° C. and lower than 60° C.

In the step (C), the sheet-shaped polyolefin resin composition can be stretched with use of a commercially available stretching apparatus.

In the step (C), the sheet-shaped polyolefin resin composition is stretched in the MD at a stretching rate within a range of preferably 3.0 times to 7.0 times, more preferably 4.5 times to 6.5 times. Further, when the sheet-shaped polyolefin resin composition is stretched in the MD, the sheet-shaped polyolefin resin composition has a temperature of preferably not higher than 130° C., more preferably within a range of 100° C. to 130° C. The sheet-shaped polyolefin resin composition may be stretched in only the MD, only the TD, or both the MD and the TD. The sheet-shaped polyolefin resin composition can be stretched in both the MD and TD by, for example, sequential biaxial stretching (in which the sheet-shaped polyolefin resin composition is stretched in the MD first and is then stretched in the TD) or simultaneous biaxial stretching (in which the sheet-shaped polyolefin resin composition is stretched in the MD and the TD simultaneously).

The stretching operation can be carried out by a method in which chucks hold both sides of the sheet to stretch the sheet, by a method in which a roller conveys the sheet at different rotational speeds so that the sheet is stretched, or by a method in which the sheet is rolled with use of a pair of rollers.

The cleaning liquid used in the step (D) can be any solvent that can remove an additive such as a pore forming agent. Examples of the cleaning liquid include heptane and dichloromethane.

In the step (E), the cleaned polyolefin resin composition is dried for removal of the cleaning solvent. The drying operation is preferably carried out at room temperature (approximately 25° C.).

Next, the polyolefin resin composition is heat-treated at a particular temperature for heat fixing. The heat-fixing operation is carried out at a temperature within a range of preferably not lower than 110° C. and not higher than 140° C., more preferably not lower than 115° C. and not higher than 135° C., to maintain the structure and properties of the polyolefin porous film produced in the immediately previous step. The heat fixing operation is carried out over a time period within a range of preferably riot shorter than 0.5 minutes to not longer than 60 minutes, more preferably not shorter than 1 minute to not longer than 30 minutes.

[2. Nonaqueous Electrolyte Secondary Battery Laminated Separator]

According to another embodiment of the present invention, it is possible to use, as a separator, a nonaqueous electrolyte secondary battery laminated separator including (i) the nonaqueous electrolyte secondary battery separator and (ii) an insulating porous layer. Since the porous film is as described above, the insulating porous layer is described here. The description below also uses the simple term “porous layer” to refer to an insulating porous layer.

<Insulating Porous Layer>

The porous layer is normally a resin layer containing a resin and is preferably a heat-resistant layer or an adhesion layer. The resin of which the porous layer is made is preferably a resin that has a function required for the porous layer, that is insoluble in a battery electrolyte, and that is electrochemically stable when the battery is in normal use.

The porous layer is disposed on one surface or both surfaces of the nonaqueous electrolyte secondary battery separator as necessary. The porous layer is preferably disposed on one surface of the nonaqueous electrolyte secondary battery separator. In a case where the porous layer is disposed on one surface of the porous film, the porous layer is disposed preferably on that surface of the porous film which faces the positive electrode of a nonaqueous electrolyte secondary battery to be produced, more preferably on that surface of the porous film which will come into contact with the positive electrode.

Examples of the resin contained in the porous layer include polyolefins; acrylate-based resins; methacrylate-based resins; fluorine-containing resins; fluorine-containing rubbers; aromatic polyamides; wholly aromatic polyamides (aramid resins); rubbers; resins with a melting point or glass transition temperature of not lower than 180° C.; and water-soluble polymers.

Among the above resins, polyolefins, acrylate-based resins, fluorine-containing resins, aromatic polyamides, wholly aromatic polyamides, and water-soluble polymers are preferable.

The porous layer may contain fine particles. The term “fine particles” herein means organic fine particles or inorganic fine particles generally referred to as a filler. Therefore, in a case where the porous layer contains fine particles, the above resin contained in the porous layer functions as a binder resin for binding (i) fine particles with each other and (ii) fine particles with the porous film. The fine particles are preferably electrically insulating fine particles.

Examples of the organic fine particles contained in the porous layer encompass fine particles made of resin.

Specific examples of the inorganic fine particles contained in the porous layer encompass fillers made of inorganic substances such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. The porous layer may contain only one kind of the fine particles or two or more kinds of the fine particles in combination.

Among the above fine particles, fine particles made of an inorganic substance are suitable. Fine particles made of an inorganic oxide such as silica, calcium oxide, magnesium oxide, titanium oxide, alumina, mica, zeolite, aluminum hydroxide, or boehmite are more preferable. Further, fine particles made of at least one kind selected from the group consisting of silica, magnesium oxide, titanium oxide, aluminum hydroxide, boehmite, and alumina are even more preferable. Fine particles made of alumina are particularly preferable.

The porous layer contains fine particle in an amount of preferably 1% by volume to 99% by volume, more preferably 5% by volume to 95% by volume, with respect to 100% by volume of the porous layer. In a case where the porous layer contains fine particle in an amount within the above range, it is less likely for a void, which is formed when fine particles come into contact with each other, to be blocked by a resin or the like. This makes it possible to achieve sufficient ion permeability and an appropriate weight per unit area of the porous film.

The porous layer may contain a combination of two or more kinds of fine particles which kinds differ from each other in particle and/or specific surface area.

The porous layer has a thickness within a range of preferably 0.5 μm to 15 μm per single porous layer, more preferably 2 μm to 10 μm per single porous layer.

If the porous layer has a thickness of less than 1 μm, it may be impossible to sufficiently prevent an internal short circuit caused by breakage or the like of the battery. In addition, the porous layer may be only capable of retaining a reduced amount of electrolyte. If the combined thickness of porous layers on both surfaces of the nonaqueous electrolyte secondary battery separator is more than 30 μm, the rate characteristic and/or cycle characteristic may be degraded.

The porous layer has a weight per unit area per single porous layer within a range of preferably 1 g/m² to 20 g/m², more preferably 4 g/m² to 10 g/m².

The porous layer contains a porous layer constituent component in a volume per square meter per single porous layer within a range of preferably 0.5 cm³ to 20 cm³, more preferably 1 cm³ to 10 cm³, even more preferably 2 cm³ to 7 cm³.

The porous layer has a porosity within a range of preferably 20% by volume to 90% by volume, more preferably 30% by volume to 80% by volume, for sufficient ion permeability. The porous layer has pores each having a pore diameter of preferably not more than 3 μm, more preferably not more than 1 μm, so that the nonaqueous electrolyte secondary battery laminated separator will have sufficient ion permeability.

A nonaqueous electrolyte secondary battery laminated separator in accordance with an embodiment of the present invention has a thickness within a range of preferably 5.5 μm to 45 μm, more preferably 6 μm to 25 μm.

A nonaqueous electrolyte secondary battery laminated separator in accordance with an embodiment of the present invention has an air permeability within a range of preferably 30 sec/100 mL to 1000 sec/100 mL, more preferably 50 sec/100 mL to 800 sec/100 mL, in terms of Gurley values.

<Method for Producing Porous Layer>

The porous layer can be produced by, for example, a method of (i) coating a surface of the above-described porous film with a later-described coating solution and drying the coating solution to deposit a porous layer.

The coating solution for use in a method for producing a porous layer can be prepared normally by (i) dissolving a resin in a solvent and (ii) dispersing fine particles in the solution. The solvent for dissolving the resin serves also as a disperse medium for dispersing fine particles.

The solvent can be any solvent that does not adversely affect the porous film, that allows the resin to be dissolved uniformly and stably, and that allows the fine particles to be dispersed uniformly and stably. Specific examples of the solvent encompass water and an organic solvent. It is possible to use (i) only one kind of the above solvents or (ii) two or more kinds of the above solvents in combination.

The coating solution can be prepared by any method, provided that the coating solution satisfies conditions such as a resin solid content (resin concentration) and/or the amount of fine particles, each of which conditions needs to be satisfied to prepare a desired porous layer. Specific examples of the method for preparing the coating solution encompass a mechanical stirring method, an ultrasonic dispersion method, a high-pressure dispersion method, and a media dispersion method. The coating solution can contain an additive(s) such as a dispersing agent, a plasticizing agent, a surface active agent, and a pH adjusting agent as a component(s) other than the resin and the fine particles as long as such an additive(s) does not prevent an object of the present invention from being attained.

The coating solution can be applied to the porous film by any method, that is, a porous layer can be formed by any method on a surface of a polyolefin porous film. The porous layer may, as necessary, be formed on a surface of a porous film that has been subjected to a hydrophilization treatment.

The porous layer can be formed by, for example, a method including the steps of applying the coating solution directly to a surface of the porous film and then removing the solvent (dispersion medium), a method including the steps of applying the coating solution to an appropriate support, removing the solvent (dispersion medium) to form a porous layer, then pressure-bonding the porous layer to the porous film, and subsequently peeling the support off, or (iii) a method including the steps of applying the coating solution to a surface of an appropriate support, then pressure-bonding the porous film to that surface of the support, then peeling the support off, and subsequently removing the solvent (dispersion medium).

The coating solution can be applied by a conventionally publicly known method. Specific examples of such a method include a gravure coater method, a dip coater method, a bar coater method, and a die coater method.

The solvent is typically removed by a drying method. The solvent contained in the coating solution can be replaced with another solvent before a drying operation.

[3. Nonaqueous Electrolyte Secondary Battery Member]

A nonaqueous electrolyte secondary battery member in accordance with an embodiment of the present invention includes a positive electrode, the nonaqueous electrolyte secondary battery separator described above or the nonaqueous electrolyte secondary battery laminated separator described above, and a negative electrode, the positive electrode, the nonaqueous electrolyte secondary battery separator or the nonaqueous electrolyte secondary battery laminated separator, and the negative electrode being arranged in this order.

<Positive Electrode>

The positive electrode is not limited to any particular one, provided that the positive electrode is one that is typically used as the positive electrode of a nonaqueous electrolyte secondary battery. Examples of the positive electrode encompass a positive electrode sheet having a structure in which an active material layer containing a positive electrode active material and a binder resin is formed on a current collector. The active material layer can further contain an electrically conductive agent and/or a binding agent.

Examples of the positive electrode active material encompass a material capable of being doped and dedoped with lithium ions. Specific examples of such a material include a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination.

Examples of the binding agent encompass (i) fluorine-based resins such as polyvinylidene fluoride, (ii) acrylic resin, and (iii) styrene butadiene rubber. Note that the binding agent serves also as a thickener.

Examples of the positive electrode current collector encompass electric conductors such as Al, Ni, and stainless steel. Among these, Al is more preferable because Al is easily processed into a thin film and is inexpensive.

Examples of a method for producing the positive electrode sheet encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) a positive electrode current collector is coated with the paste, and then (iii) the paste is dried and then pressured so that the paste is firmly fixed to the positive electrode current collector.

<Negative Electrode>

The negative electrode is not limited to any particular one, provided that the negative electrode is one that is typically used as the negative electrode of a nonaqueous electrolyte secondary battery. Examples of the negative electrode encompass a negative electrode sheet having a structure in which an active material layer containing a negative electrode active material and a binder resin is formed on a current collector. The active material layer can further contain an electrically conductive agent.

Examples of the negative electrode active material encompass (i) a material capable of being doped and dedoped with lithium ions, (ii) a lithium metal, and (iii) a lithium alloy. Examples of the material encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in the case of a lithium ion secondary battery and is easily processed into a thin film.

Examples of a method for producing the negative electrode sheet encompass: a method in which a negative electrode active material is pressure-molded on a negative electrode current collector; and a method in which (i) a negative electrode active material is formed into a paste with the use of a suitable organic solvent, (ii) a negative electrode current collector is coated with the paste, and then (iii) the paste is dried and then pressured so that the paste is firmly fixed to the negative electrode current collector.

The paste preferably contains the electrically conductive agent and the binding agent.

A nonaqueous electrolyte secondary battery member in accordance with an embodiment of the present invention can be produced by, for example, arranging the above positive electrode, the above-described nonaqueous electrolyte secondary battery separator or the above-described nonaqueous electrolyte secondary battery laminated separator, and the above negative electrode in this order. The nonaqueous electrolyte secondary battery member may be produced by any method, and may be produced by a conventionally publicly known method.

[4. Nonaqueous Electrolyte Secondary Battery]

A nonaqueous electrolyte secondary battery in accordance with an embodiment of the present invention includes the above-described nonaqueous electrolyte secondary battery separator or the above-described nonaqueous electrolyte secondary battery laminated separator.

The nonaqueous electrolyte secondary battery may be produced by any method, and may be produced by a conventionally publicly known method. For instance, a nonaqueous electrolyte secondary battery member is produced by the method described above, and then the nonaqueous electrolyte secondary battery member is inserted into a container that serves as a housing of a nonaqueous electrolyte secondary battery. Subsequently, the container is filled with a nonaqueous electrolyte, and is then hermetically sealed under reduced pressure. This produces a nonaqueous electrolyte secondary battery in accordance with an embodiment of the present invention.

<Nonaqueous Electrolyte>

The nonaqueous electrolyte is not limited to any particular one, provided that the nonaqueous electrolyte is one that is typically used as the nonaqueous electrolyte of a nonaqueous electrolyte secondary battery. Examples of the nonaqueous electrolyte include a nonaqueous electrolyte prepared by dissolving a lithium salt in an organic solvent. Examples of the lithium salt encompass LiClO₄, PiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCL₄. It is possible to use (i) only one kind of the above lithium salts or (ii) two or more kinds of the above lithium salts in combination.

Examples of the organic solvent contained in the nonaqueous electrolyte encompass carbonates, ethers, esters, nitriles, amides, carbamates, sulfur-containing compounds, and fluorine-containing organic solvents obtained by introducing a fluorine group into any of these organic solvents. It is possible to use (i) only one kind of the above organic solvents or (ii) two or more kinds of the above organic solvents in combination.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in greater detail with reference to Examples and Comparative Examples. Note, however, that the present invention is not limited to the Examples and Comparative Examples below.

[Measurement]

The Examples and Comparative Examples below each measured an average outermost surface area and a cycle characteristic by the methods described below.

<Average Outermost Surface Area>

The outermost surface area was measured with use of a scanning probe microscope (SFT-3500, available from Shimazu Corporation) in a contact mode by scanning a 10 μm×10 μm region of a surface of the porous film. This measurement was made at four portions of the porous film, and the average of the four measurements was calculated.

<Air Permeability>

The air permeability of a polyolefin porous film was measured in conformity with JIS P8117.

<Cycle Characteristic>

### (1) Initial Charge/Discharge Test

Nonaqueous electrolyte secondary batteries were subjected to four cycles of initial charge and discharge each of which nonaqueous electrolyte secondary batteries included a corresponding one of the nonaqueous electrolyte secondary battery separators produced in the Examples and the Comparative Examples and each of which nonaqueous electrolyte secondary batteries had not undergone a charge and discharge cycle. Each of the four cycles of the initial charge and discharge was carried out at 25° C., at a voltage within a range of 4.1 V to 2.7 V, and at a current value of 0.2 C. The present specification assumes that the value of an electric current at which a battery rated capacity defined as a one-hour rate discharge capacity was discharged in one hour was 1 C.

### (2) Cycle Test

Subsequently, the nonaqueous electrolyte secondary batteries were each subjected to 100 cycles of charge and discharge. Each of the 100 cycles was carried out at 55° C., at a voltage within a range of 4.2 V to 2.7 V, at a constant charge electric current value of 1 C, and at a constant discharge electric current value of 10 C.

The discharge capacity maintaining ratio after 100 cycles was calculated in accordance with the following formula:

Discharge capacity maintaining ratio (%)=(discharge capacity at 100th cycle/discharge capacity at 1st cycle after initial charge and discharge)×100

[Production of Nonaqueous Electrolyte Secondary Battery Separator]

### Example 1

First, 18% by weight of ultra-high molecular weight polyethylene powder (Hi-zex Million 145M, available from Mitsui Chemicals, Inc.) and 2% by weight of an additive (alicyclic saturated hydrocarbon resin having a softening point within a range of 85° C. to 95° C.) were prepared. Powder of these ingredients was crushed and mixed in a blender until the powder had a uniform particle diameter. Then, the mixed powder thus prepared was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 184° C. immediately after the liquid paraffin was added. The resin pressure at the outlet of the kneader was 7.0 MPa.

Then, the resulting melt-kneaded product was extruded through a T-die via a gear pump. This prepared a polyolefin resin composition.

The polyolefin resin composition was cooled with use of a cooling roller having a temperature of 40° C. This produced a roll of a sheet-shaped polyolefin resin composition.

The sheet-shaped polyolefin resin composition produced as above was stretched 6.0-fold at 118° C. in the MD and the TD simultaneously. The stretched polyolefin resin composition in the form of a sheet was immersed in heptane for removal of the liquid paraffin. The polyolefin resin composition was dried at room temperature, and was then heat-fixed in an oven at 125° C. for 5 minutes. This produced a nonaqueous electrolyte secondary battery separator having a film thickness of 10.8 μm and an air permeability of 88 sec/100 mL.

### Example 2

First, 18% by weight of ultra-high molecular weight polyethylene powder (Hi-zex Million 145M, available from Mitsui. Chemicals, Inc.) and 2% by weight of an additive (alicyclic saturated hydrocarbon resin having a softening point within a range of 85° C. to 95° C.) were prepared. Powder of these ingredients was crushed and mixed in a blender until the powder had a uniform particle diameter. Then, the mixed powder thus prepared was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 184° C. immediately after the liquid paraffin was added. The resin pressure at the outlet of the kneader was 7.0 MPa.

Then, the resulting melt-kneaded product was extruded through a T-die via a gear pump. This prepared a polyolefin resin composition.

The polyolefin resin composition was cooled with use of a cooling roller having a temperature of 40° C. This produced a roll of a sheet-shaped polyolefin resin composition.

The sheet-shaped polyolefin resin composition produced as above was stretched 6.4-fold at 117° C. in the MD. Subsequently, the polyolefin resin composition was stretched 6.0-fold at 115° C. in the TD.

The stretched polyolefin resin composition in the form of a sheet was immersed in heptane for removal of the liquid paraffin. The polyolefin resin composition was dried at room temperature, and was then heat-fixed in an oven at 125° C. for 7 minutes. This produced a nonaqueous electrolyte secondary battery separator 2 having a film thickness of 13.2 μm and an air permeability of 111 sec/100 mL.

### Example 3

First, 18% by weight of ultra-high molecular weight polyethylene powder (Hi-zex Million 145M, available from Mitsui Chemicals, Inc.) and 2% by weight of an additive (alicyclic saturated hydrocarbon resin having a softening point within a range of 110° C. to 120° C.) were prepared. Powder of these ingredients was crushed and mixed in a blender until the powder had a uniform particle diameter. Then, the mixed powder thus prepared was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 188° C. immediately after the liquid paraffin was added. The resin pressure at the outlet of the kneader was 7.9 MPa.

Then, the resulting melt-kneaded product was extruded through a T-die via a gear pump at a discharge rate of 25.0 kg/h. This prepared a polyolefin resin composition.

The polyolefin resin composition was cooled with use of a cooling roller having a temperature of 40° C. This produced a roll of a sheet-shaped polyolefin resin composition.

The sheet-shaped polyolefin resin composition produced as above was stretched 6.0-fold at 118° C. in the MD and the TD simultaneously. The stretched polyolefin resin composition in the form of a sheet was immersed in heptane for removal of the liquid paraffin. The polyolefin resin composition was dried at room temperature, and was then heat-fixed in an oven at 128° C. for 10 minutes. This produced a nonaqueous electrolyte secondary battery separator 3 having a film thickness of 7.1 μm and an air permeability of 58 sec/100 mL.

### Example 4

First, 18% by weight of ultra-high molecular weight polyethylene powder (Hi-zex Million 145M, available from Mitsui. Chemicals, Inc.) and 2% by weight of an additive (alicyclic saturated hydrocarbon resin having a softening point within a range of 110° C. to 120° C.) were prepared. Powder of these ingredients was crushed and mixed in a blender until the powder had a uniform particle diameter. Then, the mixed powder thus prepared was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 188° C. immediately after the liquid paraffin was added. The resin pressure at the outlet of the kneader was 7.9 MPa.

Then, the resulting melt-kneaded product was extruded through a T-die via a gear pump. This prepared a polyolefin resin composition.

The polyolefin resin composition was cooled with use of a cooling roller having a temperature of 40° C. This produced a roll of a sheet-shaped polyolefin resin composition.

The sheet-shaped polyolefin resin composition produced as above was stretched 6.4-fold at 117° C. in the MD. Subsequently, the polyolefin resin composition was stretched 6.0-fold at 115° C. in the TD.

The stretched polyolefin resin composition in the form of a sheet was immersed in heptane for removal of the liquid paraffin. The polyolefin resin composition was dried at room temperature, and was then heat-fixed in an oven at 128° C. for 10 minutes. This produced a nonaqueous electrolyte secondary battery separator 4 having a film thickness of 12.2 μm and an air permeability of 220 sec/100 mL.

### Comparative Example 1

First, 20% by weight of ultra-high molecular weight polyethylene powder (Hi-zex Million 145M, available from Mitsui. Chemicals, Inc.) was prepared. This powder was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 182° C. immediately after the liquid paraffin was added. The resin pressure at the outlet of the kneader was 8.5 MPa.

Then, the resulting melt-kneaded product was extruded through a T-die via a gear pump. This prepared a polyolefin resin composition.

The polyolefin resin composition was cooled with use of a cooling roller having a temperature of 45° C. This produced a roll of a sheet-shaped polyolefin resin composition.

The sheet-shaped polyolefin resin composition produced as above was stretched 6.0-fold at 118° C. in the MD and the TD simultaneously. The stretched polyolefin resin composition in the form of a sheet was immersed in heptane for removal of the liquid paraffin. The polyolefin resin composition was dried at room temperature, and was then heat-fixed in an oven at 128° C. for 5 minutes. This produced a nonaqueous electrolyte secondary battery separator having a film thickness of 11.2 μm and an air permeability of 142 sec/100 mL.

### Comparative Example 2

First, 20% by weight of ultra-high molecular weight polyethylene powder (Hi-zex Million 145M, available from Mitsui Chemicals, Inc.) was prepared. This powder was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. The segment barrel of the twin screw kneading extruder had an internal temperature of 182° C. immediately after the liquid paraffin was added. The resin pressure at the outlet of the kneader was 8.5 MPa.

Then, the resulting melt-kneaded product was extruded through a T-die via a gear pump. This prepared a polyolefin resin composition.

The polyolefin resin composition was cooled with use of a cooling roller having a temperature of 45° C. This produced a roll of a sheet-shaped polyolefin resin composition.

The sheet-shaped polyolefin resin composition produced as above was stretched 6.4-fold at 117° C. in the MD. Subsequently, the polyolefin resin composition was stretched 6.0-fold at 115° C. in the TD.

The stretched polyolefin resin composition in the form of a sheet was immersed in heptane for removal of the liquid paraffin. The polyolefin resin composition was dried at room temperature, and was then heat-fixed in an oven at 128° C. for 7 minutes. This produced a nonaqueous electrolyte secondary battery separator 6 having a film thickness of 9.3 μm and an air permeability of 285 sec/100 mL.

### Comparative Example 3

First, 68% by weight of ultra-high molecular weight polyethylene powder (GUR2024, available from Ticona Corporation) and 32% by weight of polyethylene wax (FNP-0115, available from Nippon Seiro Co., Ltd.) having a weight-average molecular weight of 1,000 were prepared. Assuming that the total amount of a mixture of the ultra-high molecular weight polyethylene and the polyethylene wax was 100 parts by weight, 0.4 parts by weight of an antioxidant (Irg1010, available from Ciba Specialty Chemicals Corporation), 0.1 parts by weight of an antioxidant (P168, available from Ciba Specialty Chemicals Corporation), and 1.3 parts by weight of sodium stearate were added to the mixture. Then, calcium carbonate (available from Mar o Calcium Co., Ltd.) having an average particle diameter of 0.1 μm was further added so as to account for 38% by volume of the total volume of the resulting mixture. The resulting mixture was, while remaining in the form of powder, mixed in a Henschel mixer, and was then melt-kneaded with use of a twin screw kneading extruder. This produced a polyolefin resin composition.

The polyolefin resin composition was rolled with use of a pair of rollers each having a surface temperature of 150° C., and was gradually cooled with use of a winding roller. This sheet was immersed in an aqueous hydrochloric acid solution (containing 4 mol/L of hydrochloric acid and 0.5% by weight of a nonionic surfactant) for removal of the calcium carbonate. Subsequently, the sheet was stretched 6.2-fold at 105° C. This produced a nonaqueous electrolyte secondary battery separator 7 having a film thickness of 10.4 μm and an air permeability of 209 sec/100 mL.

[Preparation of Nonaqueous Electrolyte Secondary Battery]

Next, nonaqueous electrolyte secondary batteries including the respective nonaqueous electrolyte secondary battery separators produced as above in Examples 1 to 4 and Comparative Examples 1 to 3 were prepared as below.

<Positive Electrode>

A commercially available positive electrode was used that had been produced by applying, to an aluminum foil, LiNi_{0.5}Mn_{0.3}Co_{0.2}O₂, an electrically conductive agent, and PVDF at a weight ratio of 92:5:3. The aluminum foil was partially cut off so that a positive electrode active material layer was present in an area of 45 mm×30 mm on the aluminum foil and that a portion of the aluminum foil remained around the area which portion had a width of 13 mm and in which portion the positive electrode active material layer was absent. The positive electrode active material layer had a thickness of 58 μm and a density of 2.50 g/cm³. The positive electrode had a capacity of 174 mAh/g.

<Negative Electrode>

A commercially available negative electrode was used that has been produced by applying, to a copper foil, graphite, styrene-1,3-butadiene copolymer, and sodium carboxymethylcellulose at a weight ratio of 98:1:1. The copper foil was partially cut off so that a negative electrode active material layer was present in an area of 50 mm×35 mm on the copper foil and that a portion of the copper foil remained around the area which portion had a width of 13 mm and in which portion the negative electrode active material layer was absent. The negative electrode active material layer had a thickness of 49 μm and a density of 1.40 g/cm³. The negative electrode had a capacity of 372 mAh/g.

<Assembly>

In a laminate pouch, the positive electrode, the nonaqueous electrolyte secondary battery separator, and the negative electrode were disposed on top of each other in this order so as to obtain a nonaqueous electrolyte secondary battery member. During this operation, the positive electrode and the negative electrode were arranged so that the positive electrode active material layer of the positive electrode had a main surface that was entirely covered by the main surface of the negative electrode active material layer of the negative electrode.

Subsequently, the nonaqueous electrolyte secondary battery member was put into a bag made of a laminate of an aluminum layer and a heat seal layer. Further, 0.23 mL of nonaqueous electrolyte was put into the bag. The nonaqueous electrolyte was an electrolyte having a temperature of 25° C. and prepared by dissolving LiPF₆ in a mixed solvent of ethyl methyl carbonate, diethyl carbonate, and ethylene carbonate at a volume ratio of 50:20:30 so that the concentration of LiPF₆ in the electrolyte was 1.0 mole per liter. The bag was then heat-sealed while the pressure inside the bag was reduced. This produced a nonaqueous electrolyte secondary battery. The nonaqueous electrolyte secondary battery had a design capacity of 20.5 mAh.

[Measurement Results]

Table 1 shows the measurement results.

TABLE 1

| | Production | Average outermost | Capacity maintaining |
|---|---|---|---|
| | method | surface area [μm²] | ratio [%] |
| Example 1 | Simultaneous | 105.5 | 80 |
| Example 2 | Sequential | 108.7 | 86 |
| Example 3 | Simultaneous | 115.5 | 76 |
| Example 4 | Sequential | 111.3 | 92 |
| Comparative | Simultaneous | 105.0 | 65 |
| Example 1 | | | |
| Comparative | Sequential | 104.0 | 70 |
| Example 2 | | | |
| Comparative | — | 116.3 | 67 |
| Example 3 | | | |

In Comparative Examples 1 and 2 (in each of which the average outermost surface area was less than 105.5 μm²), the capacity maintaining ratio was not more than 70%. This was presumed to be because a small area of contact between the electrode composite layer and the nonaqueous electrolyte secondary battery separator easily led to displacement caused by the electrode composite layer expanding and shrinking during charge and discharge cycles and decreased the capacity maintaining ratio as a result.

In Comparative Example 3 (in which the average outermost surface area was more than 115.5 μm²), the capacity maintaining ratio was not more than 70% as well. This was presumed to be because a large area of contact between the electrode composite layer and the nonaqueous electrolyte secondary battery separator easily led to degradation of the resin included in the nonaqueous electrolyte secondary battery separator or deposition of lithium inside the battery and decreased the capacity maintaining ratio as a result.

In Examples 1 to 4 (in each of which the average outermost surface area was within a range of 105.5 μm² to 115.5 μm²), the capacity maintaining ratio was not less than 75%. This proves that the respective nonaqueous electrolyte secondary battery separators of Examples 1 to 4 would each allow a nonaqueous electrolyte secondary battery including the nonaqueous electrolyte secondary battery separator to have an excellent cycle characteristic.

### INDUSTRIAL APPLICABILITY

A nonaqueous electrolyte secondary battery separator in accordance with an embodiment of the present invention and a nonaqueous electrolyte secondary battery laminated separator in accordance with an embodiment of the present invention are suitably usable in production of a nonaqueous electrolyte secondary battery having an excellent cycle

1. A nonaqueous electrolyte secondary battery separator, comprising:
a polyolefin porous film,
the polyolefin porous film having, over a 10 μm×10 μm region thereof, an average outermost surface area within a range of not less than 105.5 μm² and not more than 115.5 μm² which average outermost surface area has been measured under a scanning probe microscope.

2. A nonaqueous electrolyte secondary battery laminated separator, comprising:
a nonaqueous electrolyte secondary battery separator according to claim 1; and
an insulating porous layer.

3. A nonaqueous electrolyte secondary battery member, comprising:
a positive electrode;
a nonaqueous electrolyte secondary battery separator according to claim 1; and
a negative electrode,
the positive electrode, the nonaqueous electrolyte secondary battery separator, and the negative electrode being arranged in this order.

4. A nonaqueous electrolyte secondary battery, comprising:
a nonaqueous electrolyte secondary battery separator according to claim 1.

5. A nonaqueous electrolyte secondary battery member, comprising:
a positive electrode;
a nonaqueous electrolyte secondary battery laminated separator according to claim 2; and
a negative electrode,
the positive electrode, the nonaqueous electrolyte secondary battery separator, and the negative electrode being arranged in this order.

6. A nonaqueous electrolyte secondary battery, comprising:
a nonaqueous electrolyte secondary battery laminated separator according to claim 2.
